(19) United States
(12) Patent Application Publication
(10) Pub. No.: US 2005/0072718 A1
(43) Pub. Date: Apr. 7, 2005

(54) System and device to treat sanitary and municipal wastewater and storm water run-offs

(76) Inventors: William J. Lacy, Manassas, VA (US); Alexander Blake, Holmdel, NJ (US)

Correspondence Address: ALEXANDER BLAKE, 4 Walnut Hollow Lane, Holmdel, NJ, 07733, US

(21) Appl. No.: 10/755,261

(22) Filed: Jan. 12, 2004

Related U.S. Application Data
(60) Provisional application No. 60/508,912, filed on Oct. 7, 2003.

(51) Int. Cl. B01D 35/14

(52) U.S. Cl. 210/96.1; 210/151; 210/259; 210/630; 210/335; 210/137

(57) ABSTRACT

The system and device of the present invention is a technology designed to meet the biological nutrient removal requirements for the treatment of sanitary and municipal wastewater, storm water run-offs and other biologically contaminated water. This technology dies not require the addition of water treatment chemicals. The treatment process of the present invention removes BOD loading, converts nitrogenous loading to nitrates, removes the nitrates, phosphorus and kills coliform and other bacteria, as well as parasites and fungi.

### BACKGROUND OF THE INVENTION

The present invention is applicable to the treatment of sanitary and municipal wastewater and storm water run-offs, as well as other biologically contaminated water. The system and device of this invention may also apply to the treatment of other water and wastewater. However, such possible use has to be determined by tests on a case by case basis. This system and device removes, for example, BOD loading, total suspended solids, total nitrogen, total phosphorus, and also kills coliform and other bacteria, parasites and fungi.

Presently available and used methods for the treatment of above mentioned water and wastewater involve extensive treatment systems and the use of chemicals. The system and device of the present invention alleviates the necessity of extensive systems and the use of chemicals in the treatment process. In addition, the system and device of the present invention offers a reduction of approximately sixty percent of the capital equipment cost. The operation and maintenance costs are also considerably reduced.

### SUMMARY OF THE INVENTION

The system and device of the present invention utilizes a grinder pump in which large objects or particulates are ground. The larger particulates which remain after passing through the grinder pump and which remain in the water, are then removed from the water with the use of separators and a series of filter screens of different pore sizes. The water then flows through a series of anaerobic, aerobic and anoxic treatment chambers and a final ultraviolet or ozone disinfection process.

The system and device of the present invention not only reduces the BOD loading to acceptable limits, but also removes suspended solids, nitrogen, phosphorus, and kills coliform and other bacteria, as well as parasites and fungi, which is not the case with conventional treatment processes. The system and device of this invention uses no chemical addition.

The system and device of the present invention can be designed in any size to treat any flow volume.

### DESCRIPTION OF THE DRAWINGS

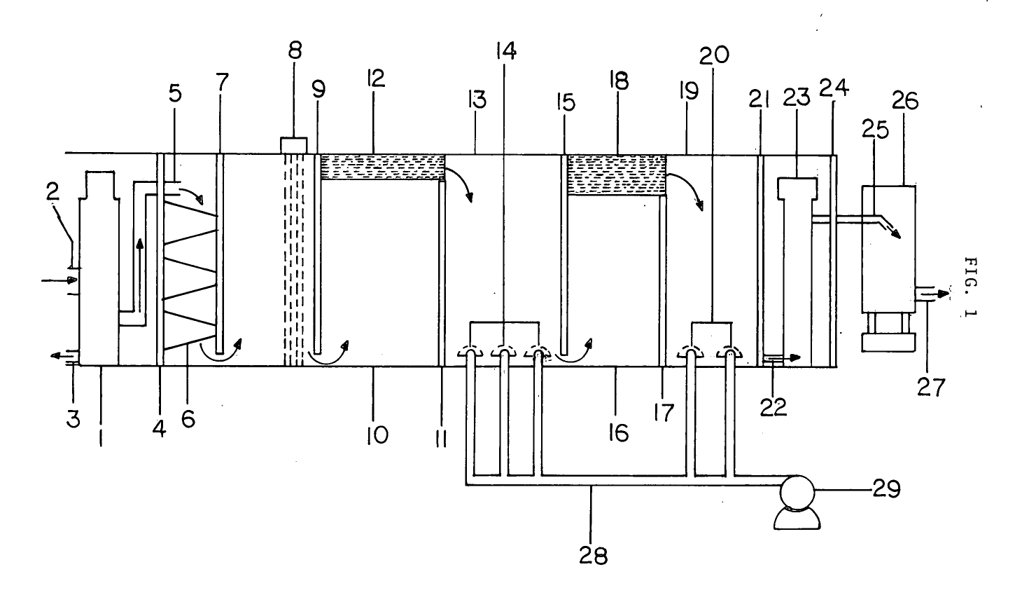

FIG. 1
1. Grinder pump
2. Raw waste intake of grinder pump.
3. Grit discharge
4. Separation between grinder pump and separators
5. Grinder pump discharge into separators
6. Separators
7. Separation
8. Filter screens
9. Chamber separation
10. Anaerobic treatment chamber
11. Chamber separation
12. Overflow filter
13. Aerobic treatment chamber
14. Perforated air manifolds
15. Chamber separation
16. Anoxic treatment chamber
17. Chamber separation
18. Overflow filter
19. Aerobic treatment chamber
20. Perforated air manifolds
21. Chamber separation
22. Pipe into ultraviolet or ozone disinfection unit
23. Ultraviolet or ozone disinfection unit
24. Endplate
25. Pipe from disinfection unit into continuous quality monitor
26. Ultraviolet or ozone disinfection unit
27. Treated water discharge
28. Air supply line
29. Air blower

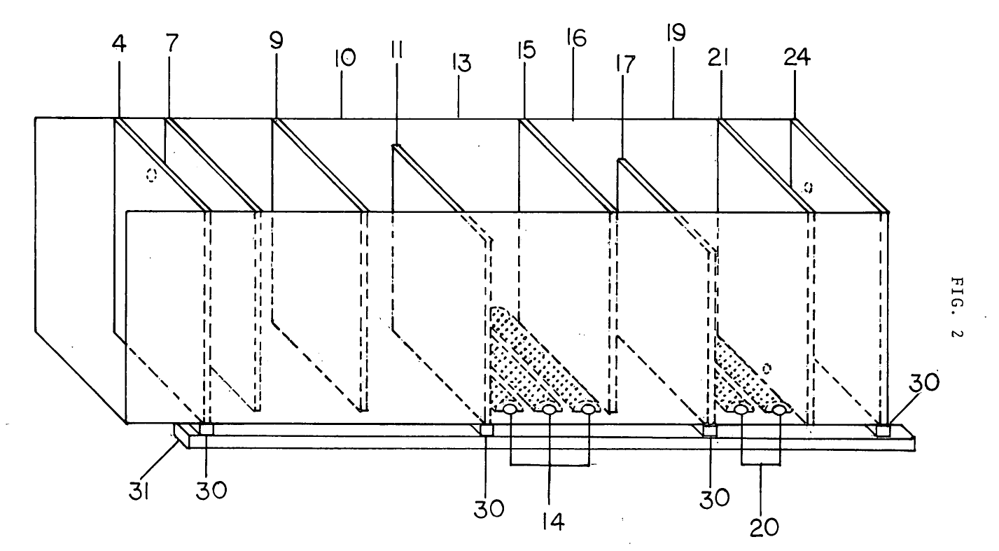

FIG. 2
4. Separation between grinder pump and separators
7. Separation
9. Chamber separation
10. Anaerobic treatment chamber
11. Chamber separation
13. Aerobic treatment chamber
14. Perforated air manifolds
15. Chamber separation
16. Anoxic treatment chamber
17. Chamber separation
19. Aerobic treatment chamber
20. Perforated air manifolds
21. Chamber separation
24. Endplate
30. Cross supports
31. Length supports

### DESCRIPTION OF THE PREFERRED EMBODIMENTS

The system and device of the present invention is designed to treat sanitary and municipal wastewater, storm water run-offs, as well as other biologically contaminated water to meet biological nutrient removal requirements. The present invention does not require the addition of treatment chemicals to achieve a high quality of the effluent. The system and device of this invention may also apply to the treatment of other types of water or wastewater, which has to be determined in tests on a case by case basis.

The influent is entered into a grinder pump 1 through the grinder pump raw waste intake 2. The grinder pump 1 grinds larger waste solids or particulates. The grit from the grinder pump 1 is discharged through the grit discharge 3. The water, with the settled grit separated, flows through opening 5 in the separation 4 between grinder pump and separators 6 and flows down through the separators 6 to remove larger solids or particulates. The water then flows under separation 7 and flows up and through a series of filter screens 8 of different pore sizes to remove remaining particulates. The separators may be of a plate type, weir type or other type and may be arranged diagonal, horizontal or in some other configuration. After passing through the series of filter screens 8, the water flows under the short chamber separation 9 and flows up into the anearobic treatment chamber 10 in which most of the BOD loading is removed. From the anaerobic treatment chamber 10 the water flows through a filter 12 and overflows the chamber separation 11 into the aerobic treatment chamber 13 to remove the remaining BOD and to convert the nitrogenous loading to nitrates. The air is entered into the aerobic treatment chamber 13 through the perforated air manifolds 14. The air is supplied through the air supply line 28 by air blower 29. The water then flows from the aerobic treatment chamber 13 under the short chamber separation 15 up into the anoxic treatment chamber 16 where the nitrates are gasified to nitrogen. From the anoxic treatment chamber 16 the water flows through filter 18 and overflows the chamber separation 17 into the aerobic treatment chamber 19 where the water is reaerated. The air is entered into the aerobic treatment chamber 19 through the perforated air manifolds 20. The air to the perforated air manifolds 20 is also supplied through the air supply line 28 by air blower 29. In the aerobic treatment chamber 19 the oxidative treatment is completed. The number of perforated air manifolds 14 and 20 varies with the size of the treatment system and device of the present invention and therefore the capacity of the aerobic treatment chamber 13 and 19. From the aerobic treatment chamber 19 the water flows through an opening with a pipe or hose connection into the ultraviolet or ozone disinfection unit 23 where the coliform and other bacteria, as well as parasites and fungi are killed. After flowing up through the ultraviolet or ozone disinfection unit 23 the water passes through a pipe or hose 25, which is located through the Endplate 24, into the continuous quality monitor 26. From the continuous quality monitor, the treated water is discharged through the treated water discharge opening 27. The purpose of the continuous quality monitor 26 is to assure a continuous high quality of the effluent and to monitor the effecient function of the system.

The size and therefore the volume of the aerobic treatment chamber 13 is than that of the anoxic treatment chamber 16 to apply sufficient pressure to force the water to underflow the chamber separation 15 and flow up into the anoxic treatment chamber 16. The same is true for the aerobic treatment chamber 19 which is larger than the ultraviolet or ozone disinfection unit 23 in volume and therefore forces the water to flow through the pipe or hose 22 and up through the ultraviolet or ozone disinfection unit 23.

The cover or covers of the system and device of the present invention, not illustrated, is of one piece on small systems and sectional on larger systems. The cover or covers can be opened to allow periodic cleaning of the solids and particulates filtering and removal parts of the system.

It is to be understood that, depending on the size of the system and device of this invention and the volume of wastewater to be treated, the design may include a multiplicity of each treatment step with more than one treatment chamber for each treatment phase.

It is also to be understood that, depending on the application and flow volume, all components may not have to be included in the design of a system and device of the present invention.

The chamber containing the separators 6 and the filter screens 8 may be provided with a drain at the bottom, which is not illustrated, to remove any settled solids or grit which may be required from time to time.

The system and device of the present invention may also apply to the treatment of agricultural run-offs from fields, such as sugar cane fields.

1) A system and device which treats sanitary and municipal wastewater, storm water run-offs and other biologically contaminated water.

2) A system and device per claim 1 to meet biological nutrient removal requirements without chemical addition.

3) A continuous system and device per claim 1 utilizing a grinder pump to reduce solids and large particulates in size.

4) A system and device per claim 1 utilizing separators and filter screens of different pore sizes as first filtering step in the progression of the continuous treatment process.

5) A system and device per claim 1 which treats sanitary and municipal wastewater, storm water run-offs and other biologically contaminated water in one continuous process in one system.

6) A system and device per claim 1 which includes anaerobic, aerobic and anoxic treatment in succession in one system.

7) A system and device per claim 1 using ultraviolet or ozone disinfection as the final treatment phase in a continuous treatment system.

8) A system and device per claim 1 which uses a continuous waster quality monitoring device from which the treated water is discharged from the system.

9) A system and device per claim 1 utilizing filters at the top of the anaerobic and anoxic treatment chambers to isure removal particulates before overflow into the next treatment chamber.
